(19) United States
(12) Patent Application Publication
(10) Pub. No.: US 2014/0052580 A1
(43) Pub. Date: Feb. 20, 2014

(54) PRODUCT EXPLORER PAGE FOR USE WITH INTERACTIVE DIGITAL CATALOGS AND TOUCH-SCREEN DEVICES

(71) Applicant: KALLIDUS, INC., San Francisco, CA (US)

(72) Inventors: Arish ALI, San Francisco, CA (US); Daniel KOWTA, San Francisco, CA (US)

(73) Assignee: KALLIDUS, INC., San Francisco, CA (US)

(21) Appl. No.: 13/968,923

(22) Filed: Aug. 16, 2013

Related U.S. Application Data
(60) Provisional application No. 61/684,431, filed on Aug. 17, 2012.

(51) Int. Cl. G06Q 30/06; G06F 3/01; G06F 3/0484

(52) U.S. Cl. CPC G06Q 30/0643; G06Q 30/0623; G06Q 30/0631; G06F 3/04842; G06F 3/016
USPC 705/26.61; 705/27.2; 705/26.7

(57) ABSTRACT

An electronic product explorer page type, or “PXP” as defined herein, uses available retail imagery to create a patchwork grid of cells that allows for different sizes of product images, each product image being shown within a respective cell. In this way, layouts of such product images can be dynamically generated to highlight a feature product item by making cell containing the image of that feature product larger relative to other product images shown in other cells. This will work particularly well for showcasing to users various collections of related retail products and for cross category selling of retail products. The computer implemented method can also be used where the device is a non-touch screen device having a pointing device and the steps are replaced by movement of the pointing device which translates into the motion of a pointer on the display.

This application claims the benefit of U.S. Provisional Application No. 61/684,431, filed Aug. 17, 2012.

### FIELD OF THE INVENTION

This invention relates generally to the marketing and selling of products and services. It also relates generally to web-based (i.e. utilized by means of the virtual community that exists on the “internet” or within the “world wide web,” or “www”) methods and systems for acquiring, storing, processing, retrieving and displaying information and data. More specifically, the present invention relates to a method, system and software product that provides a “product explorer page” (“page type” or “PXP”) for use with electronic interactive digital catalogs and touch-screen devices. It also relates to such a page type that uses available retail product imagery displayed in cells to create a patchwork grid that allows for different sizes of images of retail products that are displayed on such touch-screen devices. Among other things, product layouts can be dynamically generated that highlight a feature product item by making it visually larger and by manipulating other product images relative to a desired product.

### BACKGROUND OF THE INVENTION

Today's world of electronic data processing and electronic communications allows sellers and consumers to electronically showcase, advertise and shop retail products via the internet. Although printed paper product catalogs are still used, it is recognized by these inventors that retail sellers and consumers alike are becoming more and more intrigued with the use and capabilities of current technology to aid in the searching of retail products that are sold and advertised to the consuming public. However, using and searching presently-available websites of retail sellers who advertise and sell such goods to consumers can be a labor-intensive and not fully optimized process.

In the view of these inventors, what is needed is a method, system and software product for providing much improved functionality of interactive digital catalogs for touch-screen devices and other interfaces. Indeed, electronic data processing, digital communication and tactile-actuated touch screen technologies make the software product, method and system of the present invention possible. The present invention provides consumers with a convenient and easy to use electronic platform for conducting electronic commerce via touch screen devices and further provides them with mobile capabilities for enhanced product selection.

More specifically, what is needed is an electronic product explorer page type, or “PXP” as defined above, that uses available retail imagery to create a patchwork grid of cells that allows for different sizes of product images, each product image being shown within a respective cell. In this way, layouts of such product images could be dynamically generated to highlight a feature product item by making cell containing the image of that feature product larger relative to other product images shown in other cells. This would also work particularly well for showcasing to users various collections of related retail products and for cross category selling of retail products.

### SUMMARY OF THE INVENTION

In accordance with the foregoing, these inventors have devised a method, system and software product where a new and useful electronic page type, identified herein as the “product explorer page” or PXP, can be used with interactive digital product catalogs, or catalog applications (or simply “apps”) of the type used with touch-screen devices, such as the iPad® brand tablet computer (iPad® is a registered mark of Apple Inc.). It is to be understood, however, that the electronic page type of the present invention could also be used with traditional personal computers and other personal computing devices, with or without touch screens, and with any number of interactive digital catalogs, all of which are made accessible using mobile encoding technology and personal computing devices. That is, the computing device, if it is a mobile terminal, may be any such terminal, such as a mobile phone, personal digital assistant (FDA), code division multiple access (CDMA) terminal, wideband CDMA (WCDMA) terminal, global system for mobile communications (GSM) terminal, international mobile telecommunications 2000 (IMT 2000) terminal, smart phone or universal mobile telecommunications system (UMTS) terminal, among others. The application of the present invention is not limited to any one of such devices. Further, the present invention is functional with non-mobile electronic interactive digital catalogs.

In accordance with the present invention, the inventors more specifically provide several unique features, or functionalities, as part of the interface or display type which is the subject of the present application. A first functionality of the present invention comprises a vertical “swipe” (a tactile motion of passing one's finger or a stylus across the screen of a touch screen computing device) that is used to expose product information shown within a product illustration cell and more related products within other cells. A second functionality comprises a horizontal swipe that is used within a product cell to visualize additional similar products. A third functionality of the present invention comprises a random, or “mix it up,” button to refresh the page with a new collection of products. A fourth functionality comprises a virtual “pin” button to hold an image within a cell in place while refreshing the cells that show other products. A fifth functionality comprises anchor products that can be used for selecting a product around which other products can be suggested or provided. A sixth functionality is a dynamic selection of product assortments that can be used for providing various products that are related and selected by means of an explicit selection of products chosen by a merchandiser or by means of a product selection algorithm that is based on a variety of product selection parameters. A seventh functionality is closely related to the sixth and is described herein as a personalized selection of product assortments for a specific user and a specific user profile, which profile is created based on a number of metrics. It is to be understood that the functionality described herein could also be applied to traditional desktop computers that do not have a touch screen. In the case of the non-touch screen devices, the PXP page would be used by replacing the touch gesture with a “mouse” which is a pointing device that functions by detecting two-dimensional motion relative to its supporting surface. The mouse's motion translates into the motion of a pointer on a display, which allows for fine control of a graphical user interface.

The foregoing and other features of the method, system and software product of the present invention will become apparent from the detailed description that follows.

### BRIEF DESCRIPTION OF THE DRAWINGS

FIG. 1 is a PXP default screen display generated in accordance with the present invention.

FIGS. 1A through 1C are similar exemplary screen displays that illustrate the “vertical swipe” functionality in accordance with the present invention.

FIGS. 2A through 2C are similar exemplary screen displays that illustrate the “horizontal swipe” functionality in accordance with the present invention; FIG. 2B shows blurring within a cell to illustrate that a given product is being swapped out for another product.

FIG. 3 is an exemplary screen display that illustrates the “mix it up” functionality in accordance with the present invention.

FIGS. 4A through 4C are similar exemplary screen displays that illustrate the “pin button to hold” functionality in accordance with the present invention; FIG. 4B shows blurring within all cells but one to illustrate that multiple products are being swapped out for other products.

FIGS. 5A through 5D are similar exemplary screen displays that illustrate the “anchor products” and the “dynamic selection” functionalities in accordance with the present invention; FIG. 5B shows blurring within a cell to illustrate that a given product is being swapped out for another product whereas FIG. 5C shows blurring within all cells but one to illustrate that multiple products are being swapped out for other products.

### DETAILED DESCRIPTION

As a prefatory statement, it is to be understood that the method and system of the present invention assumes usage of a specific computer program product that is used within an electronic commerce (or “e-commerce”) environment and that comprises certain system building block “components.” Those components are data structures, data processors and interfaces, and each component is a functional element. The data structures are places to organize and store data. The data processors, or processing units, are used to manipulate data by performing processes or applying algorithms to the data. The interfaces connect the data structures and the data processors to the outside world, or to other data structures and data processors, including the virtual internet-based community that exists within the “world wide web” or “www.” The program includes source code which is a list of instructions, written in a selected computer language, and then converted into computer machine language, which language the computer uses to build the software “machine” described by the instructions. The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention. It should also be understood that the method and system of the present invention is made possible by virtue of the existence of the internet. The internet offers opportunities and benefits that cannot be performed with the use of printed retail product catalogs or other more conventional promotional literature.

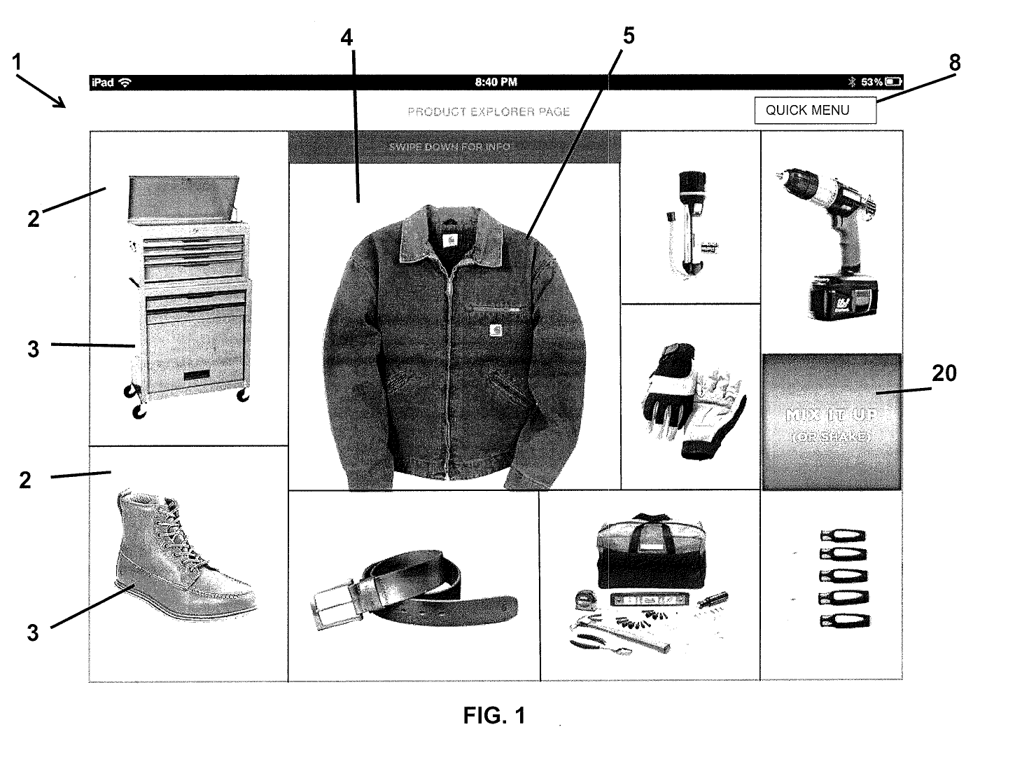

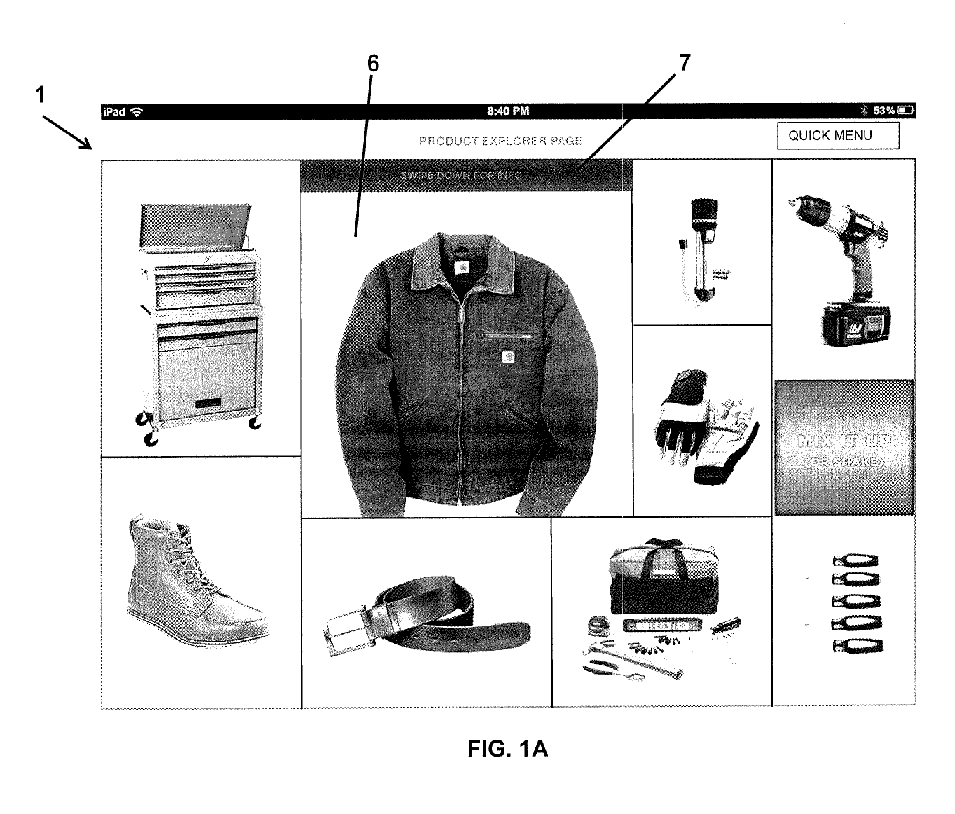

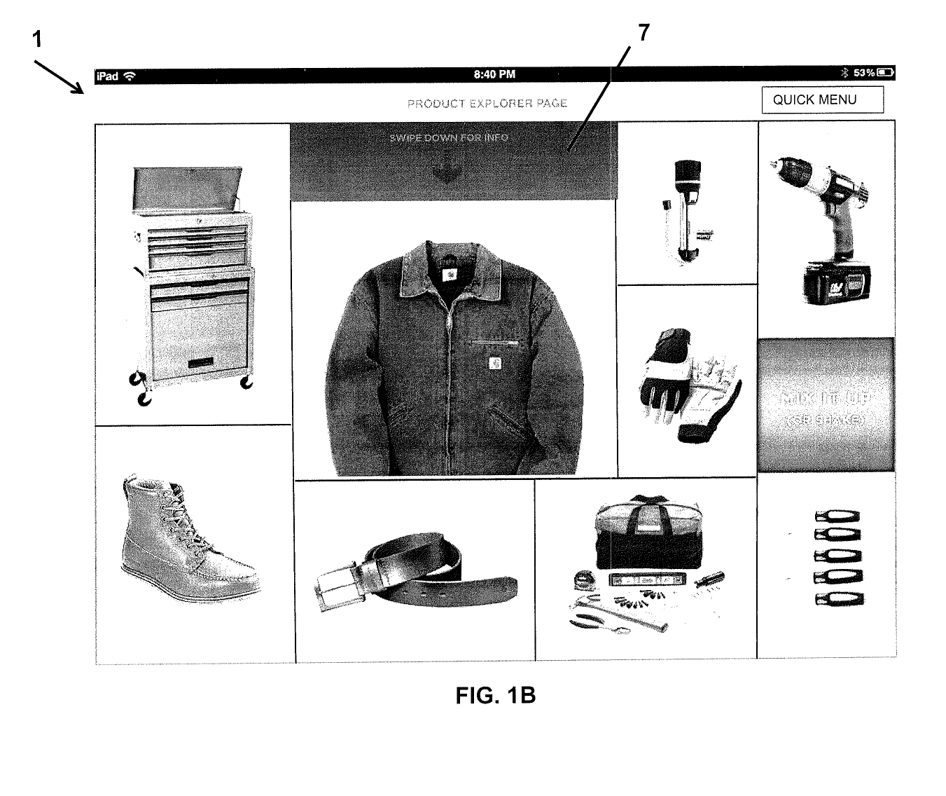

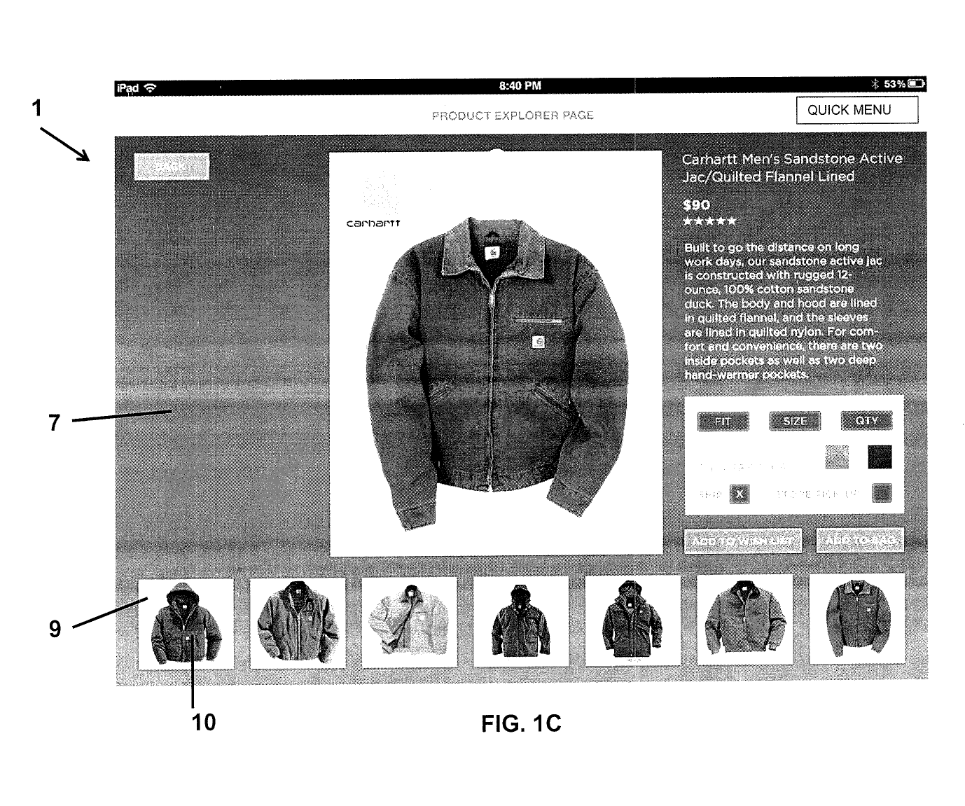

As mentioned earlier, a first feature or functionality that is provided in accordance with the present invention is the “vertical swipe” functionality which is used to expose specific product information and to identify more products that are related to a specific product. The vertical swipe functionality allows the user to control the amount of information the user obtains relative to that specific product. As shown in FIG. 1, the user is provided with a default view of a touch-screen PXP screen display (1) which is comprised of a plurality of cells (2) shown in a grid format, each cell (2) comprising an image of a product (3). The primary product image (5) is shown in a primary cell (4). It should be noted that the exact type of product, or the use to which the product is put, is not a limitation of the present invention. Further, it is to be noted that the PXP screen display (1) comprises a “patchwork” grid that allows for different sizes of product (3) images and cells (2).

For purposes of illustration only, the screen display (1) shown in FIG. 1 illustrates the image of a man's coat (5). The cell (4) for that product (5) is surrounded by other cells (2) and the other cells (2) preferably show a collection of products (3) from a particular category (8) in each cell (2). From this collection of products (3), the user makes tactile contact toward the top (6) of the preferred product cell (4) displaying the particular product (5) of interest to the user. See FIG. 1A. The functionality of the “vertical swipe” requires that the user then drag or slide his or her finger or stylus (not shown) in a vertical motion, starting at the top (6) of that product display cell (4), to initiate the display of an information layer (7) that is otherwise hidden behind the product display cell (4). See FIG. 1A. On completion of the vertical tactile movement, or “drag,” the entire product information (7) for that product (5) is shown. This is the product description page (7). See FIG. 1C. At this point, one or more footer cells (9) also appear at the bottom of the product description page (7). The footer cells (9) show more products (10) from the same category of the chosen product (5). In this example, other coats (10) are shown to the user in the footer cells (9) as optional choices to the original coat (5) chosen by the user.

It is to be understood that the functionality described above concerning the first functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

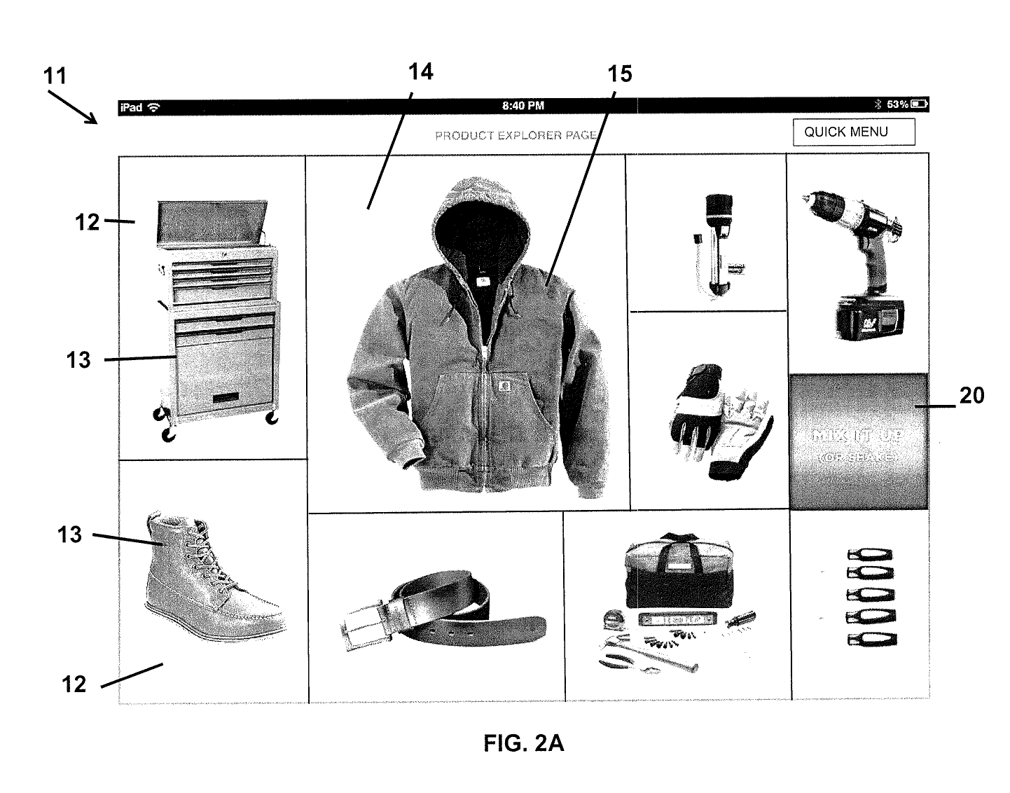

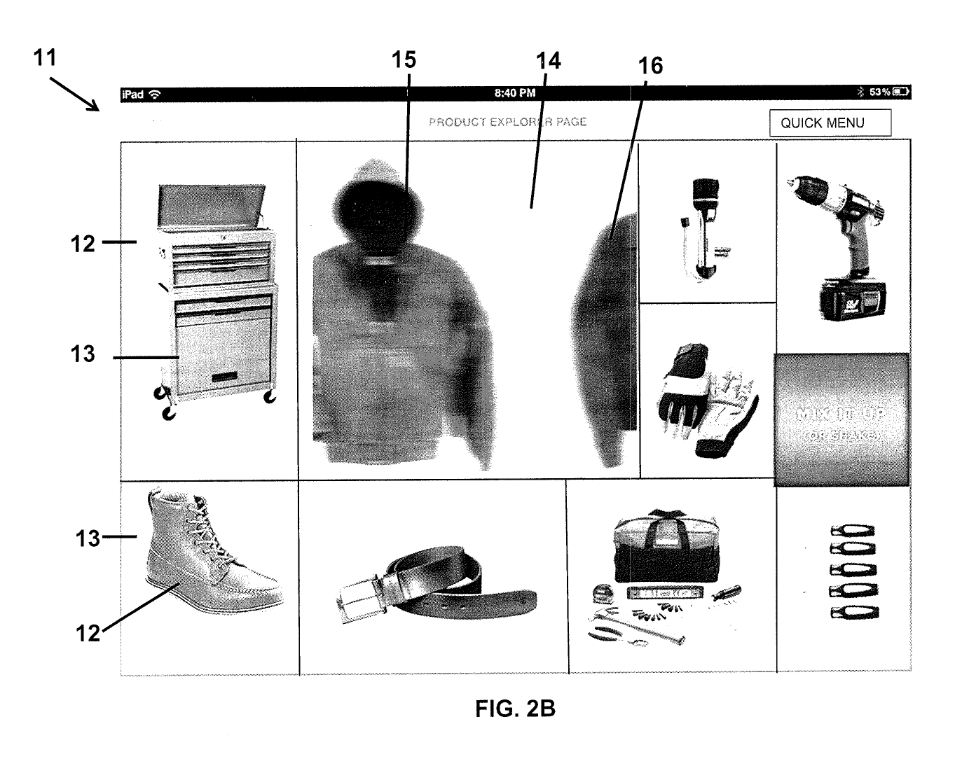

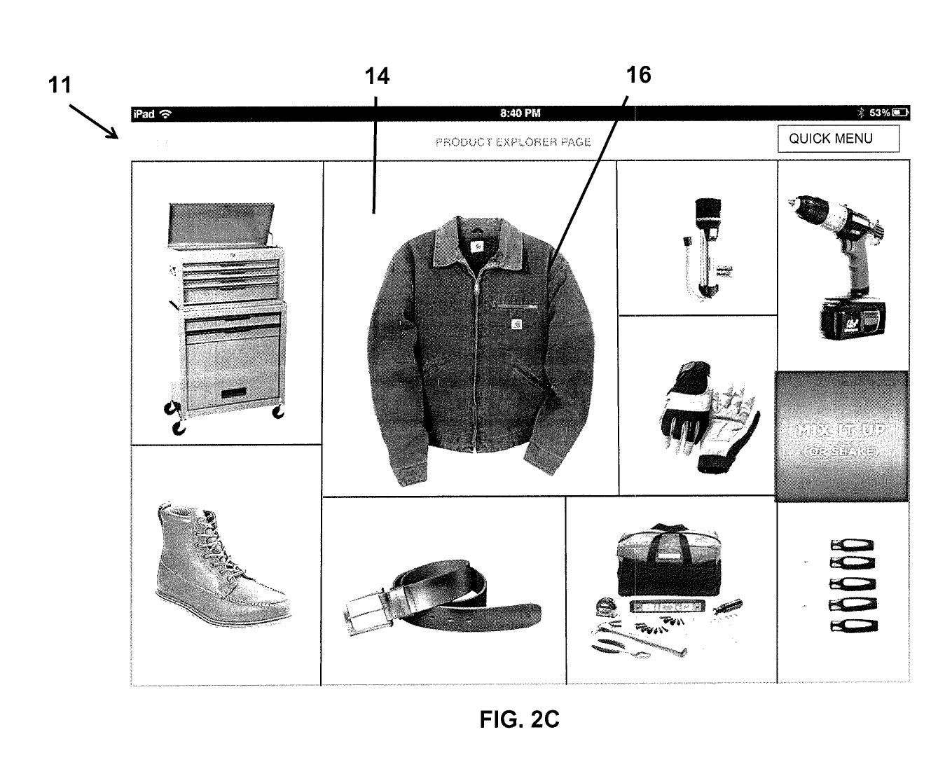

A second functionality is the “horizontal swipe” which is used to view additional similar products. As shown in FIG. 2A, the user is again provided with a PXP default screen view (11) comprised of a plurality of cells (12) showing at least one product (13) in each, and preferably a collection of products from a particular category (18). From this collection, the user again makes tactile contact within the cell (14) displaying the particular product (15) that is of interest to the user. The functionality of the “horizontal swipe” requires that the user drag or slide his or her finger or stylus (also not shown) in a horizontal motion, starting at a point within the product display cell (14). See FIG. 2A. Upon initiation of the horizontal swipe, other similar products (15) can be displayed within that same cell (14). See FIGS. 2A and 2B. FIG. 2B, in particular, shows a “blurred” image as alternative products, such as the coats (15, 16), are “moved” across the cell (14). It is to be noted that only product items (16) that are similar to the original product item (15) inside that cell (14) are shown. The remaining items (13) shown on the screen display (11) continue to be displayed within their respective cells (12). See FIG. 2C.

It is to be understood that the functionality described above concerning the second functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

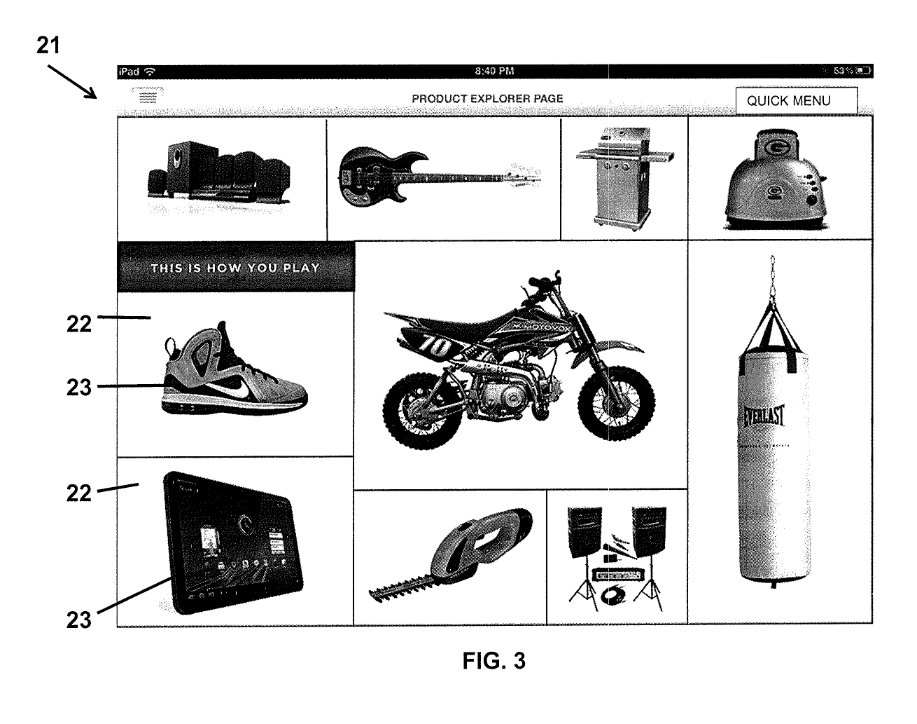

A third functionality is the random “mix it up” or the “shake it now” cell or “button” which is used to refresh a display page with a new collection of products. Beginning with the same PXP default screen view (1, 11), a “Mix it Up” cell or button (20) is displayed among the cell displays (2, 12) with the products (3, 13) shown for a given product collection in a particular category. See FIGS. 1 and 2A. Tactile touching of the “Mix it Up” button (20) changes the entire set of products that are displayed on the screen (1, 11) to another completely new set of products (23) that are displayed within cells (22) on a new screen (21). See FIG. 3. Alternatively, the display device (not shown) can be physically shaken to produce the change of cells (22) and products (23) displayed on the screen (11).

It is to be understood that the functionality described above concerning the third functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

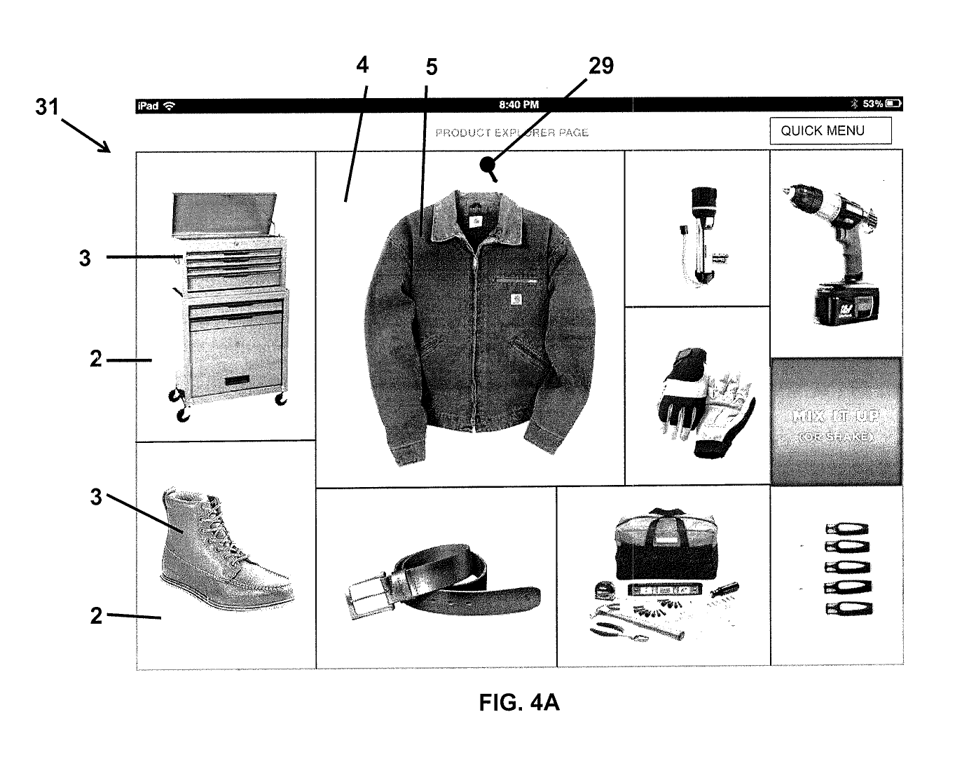

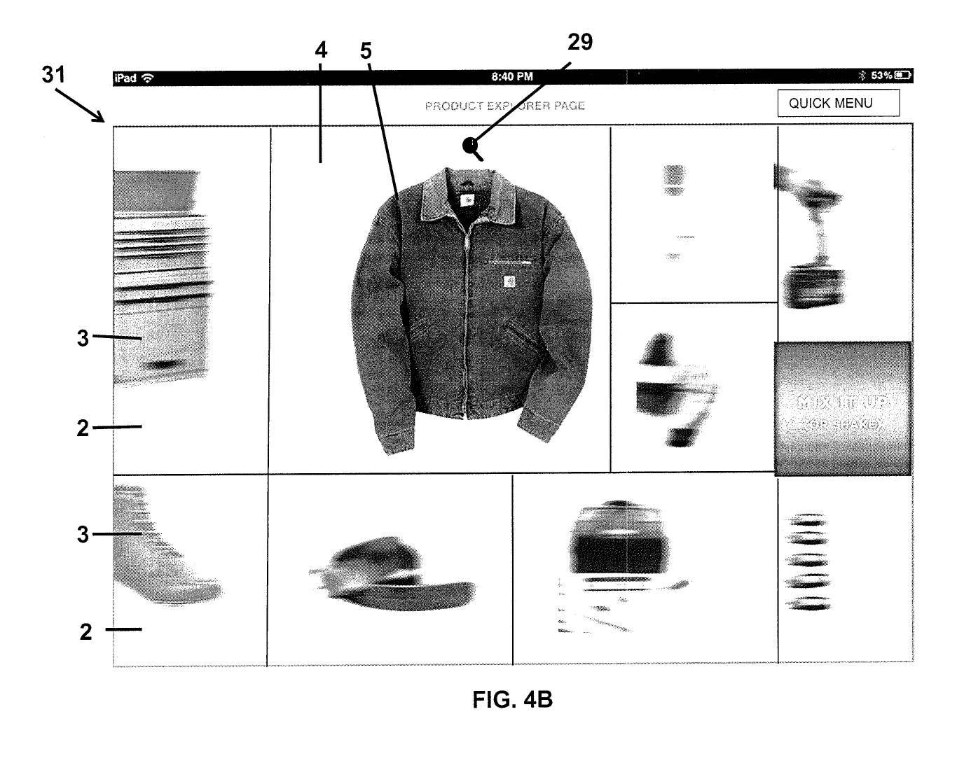

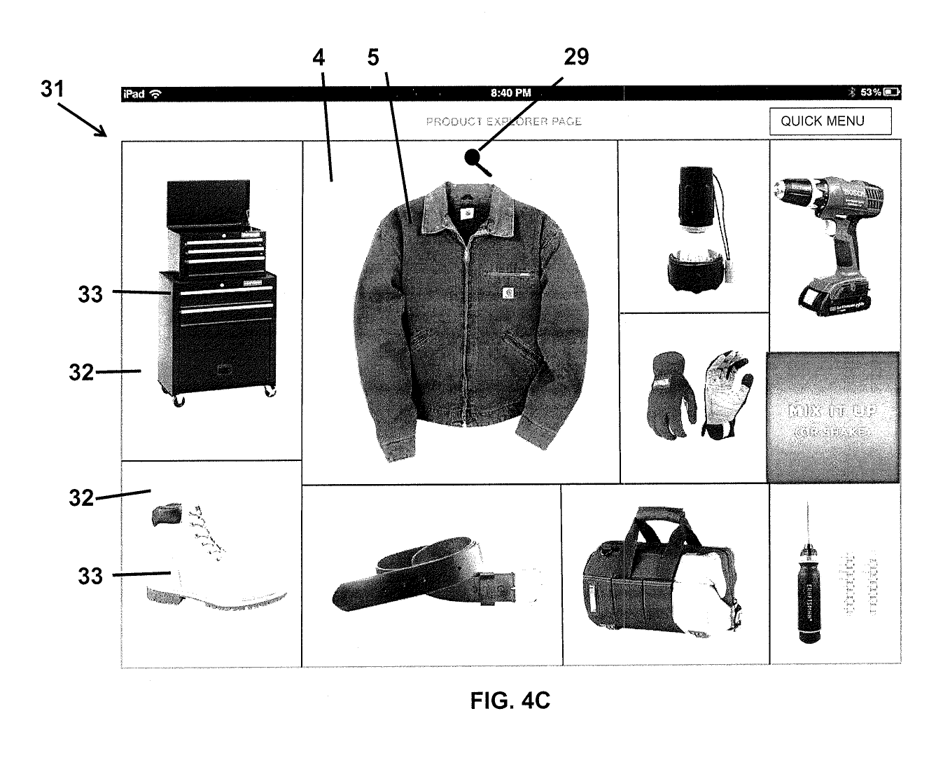

A fourth functionality is the “pin” capability which starts with the PXP default display page (1) as shown in FIG. 1. In this functionality, and while the user is exploring various products, he or she may identify a product (5) of particular interest to the user. The user is then provided with the ability to virtually “pin” that particular product (5) as it appears within its cell (4), thereby changing the display (31). See FIG. 4A. The pin (29) is visualized near the top center of the cell (4), much as a push pin would be used with a board. The user is then able to “reshuffle” the remaining displayed collection of products, retaining the product (5) that the user has “pinned” in its original place on the display page (1). See FIG. 4B. In this reshuffling, all of the products (3) of the new display (31), save the pinned product (5), are “shuffled.” This is illustrated in the display (31) as “blurred” products as original products (3) move out of the cells (2) and new products (33) are moved into the cells (32). Once this reshuffling is complete, all of the products (33) shown in their respective cells (32) except for the pinned product (5). See FIG. 4C.

It is to be understood that the functionality described above concerning the fourth functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

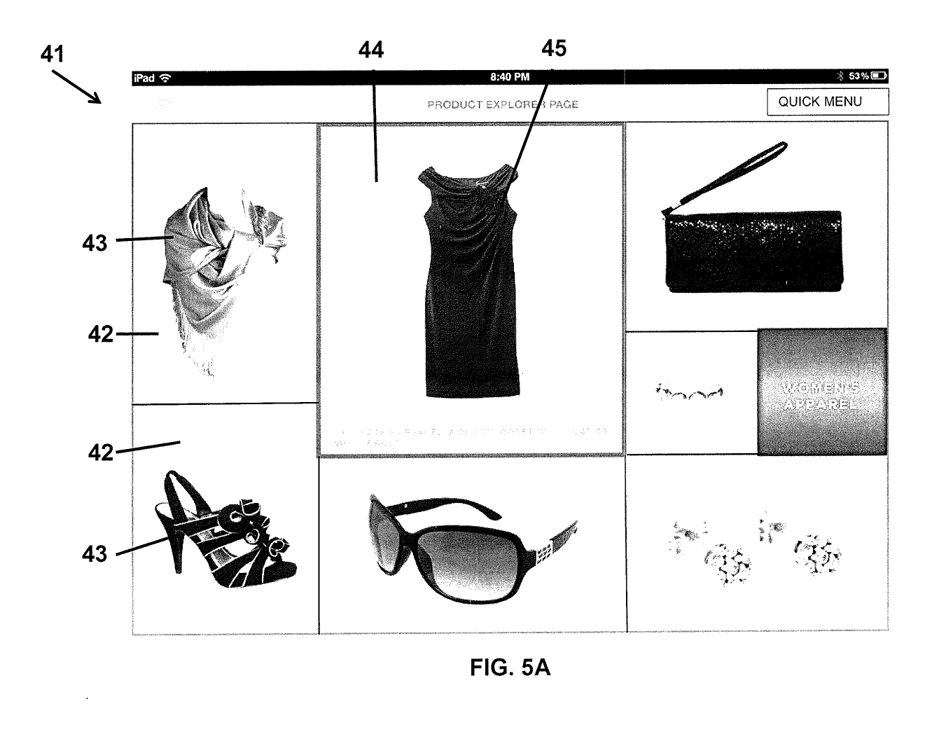

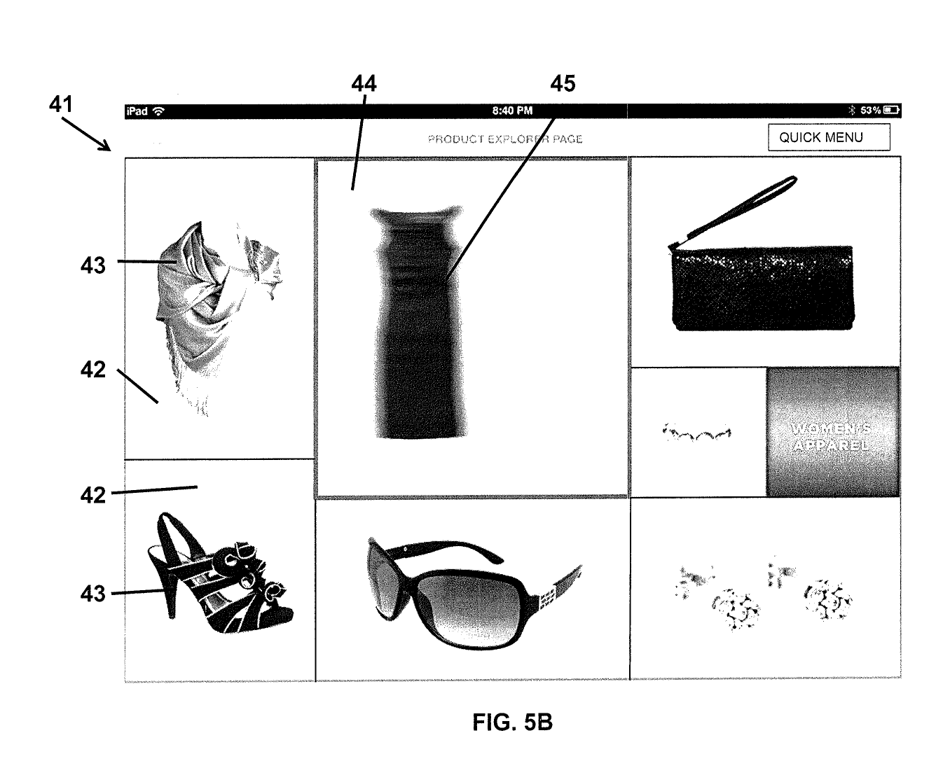

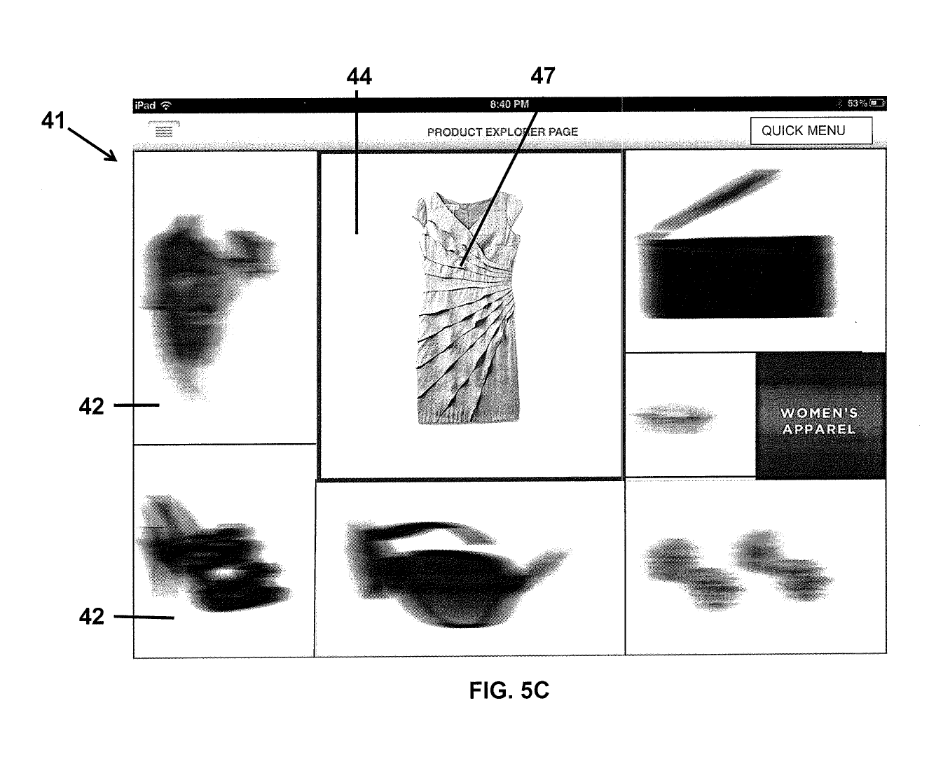

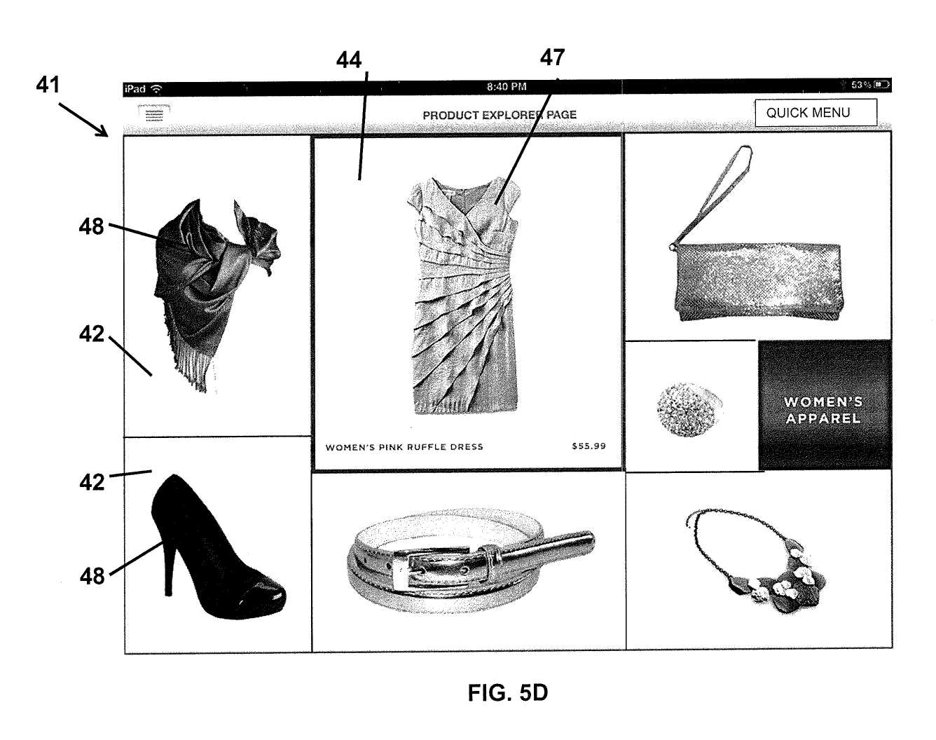

A fifth functionality is an “anchor products” capability. In this functionality, any one product (45), typically the one shown in the largest product cell (44), as shown in the PXP display screen (41) of FIG. 5A, can be the “anchor” product. All of the other cells (42) would show related accessories or products (43). If the user changes the anchor product (47), which is shown in the “anchor” product cell (44) of FIGS. 5B (shown “blurred” to denote visual movement) and 5C, then all other products (43) in the cells (42) automatically change to match the new anchor product (47). With the new given anchor product (47) in place, the user can use this product (47) in its cell (44) and opt to change the accessories (48) in the other cells (42) relative to that new “anchor” product (47). See FIGS. 5C and 5D.

It is to be understood that the functionality described above concerning the fifth functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

A sixth functionality is the dynamic selection of product assortments. That is, the set of products (45, 47) within the cells (42, 44) shown on the PXP display screen (41), respectively, can be assembled in such a way that the set of products (45, 47) come from either explicit selection by the merchandiser or they can be selected algorithmically. For example, the top rated product from each subcategory of products or, if a product is sold out, it can be replaced by a different product automatically. It is acknowledged by these inventors that, in catalog apps, an uneven grid showcasing products using smart algorithms is novel. As shown in FIG. 5D, for example, the set of products (48) that are shown along with the main product (47) in an uneven grid are not randomly selected but are algorithmically chosen based on various factors such as price, availability, promotions, and the like. The precise methodology used to choose the set of accessory products (45) in accordance with the present invention is not limited to such factors and is not limited to a specific algorithm.

It is to be understood that the functionality described above concerning the sixth functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

A seventh functionality comprises a mode where the selection of products shown in the PXP is personalized based on the user. As shown in FIG. 1, the user is again provided with a PXP default screen view (1) comprised of a plurality of cells (2) showing at least one product (3) in each, and preferably a collection of products from a particular category. In this particular functionality is based on the notion that different users see different selections of products (3) on the display (1). The display (1) provided can be due to various elements of a user's profile, such as past purchase history in the particular app as well as on the retailer's website, past browsing history, and various metrics from within the application. For example, depending on how much time a user spends on certain products or category pages in the application, that metric can be used to further refine what products (3) are shown to the user. In addition, this functionality would further like to call out the fact that the personalization can happen through metrics that are specific to the application. Similarly, if the user touches the interface display (1), or interacts with the application more for certain types of products (3) than others, and how the user interacts with those products, can be used to determine what products are shown in the PXP.

It is to be understood that the functionality described above concerning the seventh functionality could also be applied to traditional desktop computers that do not have a touch screen. In the case of the non-touch screen devices, the PXP page would be used by replacing the touch gesture with a mouse whereby the mouse's motion translates into the motion of a pointer on the display.

The details of the invention having been disclosed in accordance with the foregoing, we claim:

1. A computer implemented product explorer method for a device having a touch screen, such device comprising an interface wherein tactile motion by a the user across an onscreen display actuates a functionality, the method comprising the steps of:
electronically providing a user interface featuring an onscreen product display page that displays retail product imagery within a patchwork grid of onscreen cells, each cell illustrating a retail product therein;
electronically providing a user interface functionality to allow the user to tactilely select a retail product that is displayed within a given onscreen cell; and
electronically providing a user interface functionality to allow the user to tactilely initiate the appearance of additional onscreen information relating to the displayed product.

2. The computer implemented method of claim 1 wherein the step of tactilely initiating the appearance of additional onscreen information relating to the displayed product comprises at least one step from a group of steps consisting of:
touching and swiping the displayed product cell vertically;
touching and swiping the displayed product cell horizontally;
touching a displayed mix it up button within the cell to refresh the display with a new collection of products;
touching a displayed pin button within the cell to hold the product image within the cell while refreshing the cells that display other products;
selecting an anchor product within a cell;
dynamically selecting product assortments; and
dynamically selecting product assortments based on a preselected user profile, which profile is created based on user metrics.

3. The computer implemented method of claim 2 wherein the step of touching and swiping the displayed product cell vertically allows the user to control the amount of information the user obtains relative to the product that is displayed within the cell.

4. The computer implemented method of claim 2 wherein the step of touching and swiping the displayed product cell horizontally allows the user to view similar products to that displayed within the cell.

5. The computer implemented method of claim 2 wherein the step of touching a displayed mix it up button within the cell to refresh the display with a new collection of products changes the entire set of products that are displayed on the screen to another completely new set of products that are displayed within the cell on a new screen.

6. The computer implemented method of claim 2 wherein the step of touching a displayed pin button within the cell to hold the product image within the cell while refreshing the cells that display other products allows the user to identify a product of particular interest to the user and then reshuffle the remaining displayed collection of products, thereby retaining the product that the user has pinned in its original place on the display screen.

7. The computer implemented method of claim 2 wherein the step of selecting an anchor product within a cell allows the user to view related accessories and products in the other cells and, alternatively, select a new anchor product thereby allowing the user to view accessories and products that are related to that new anchor product.

8. The computer implemented method of claim 2 wherein the step of dynamically selecting product assortments allows the user to view cells that are assembled in such a way that the set of products come from either explicit selection by a merchandiser or selection via algorithm.

9. The computer implemented method of claim 2 wherein the step of selecting a mix it up button is alternatively replaced with a physical shaking of the device to produce the change of cells and products displayed on the screen.

10. The computer implemented method of claim 2 wherein the device is a non-touch screen device having a pointing device and the steps are replaced by movement of the pointing device which translates into the motion of a pointer on the display.

11. A computer implemented product explorer system comprising:
a processing unit;
a touch screen connected to the processing unit, the touch screen comprising a product display page that displays retail product imagery within a patchwork grid of cells, each cell illustrating a product therein; and
a touch sensing component wherein tactile motion by a the user across the screen actuates a functionality to allow the user to tactilely select a retail product that is displayed within a given cell and to allow the user to tactilely initiate the appearance of additional information relating to the displayed product.

12. The computer implemented system of claim 11 wherein the tactile initiation for the appearance of additional information relating to the displayed product comprises at least one from a group consisting of:
touching and swiping the displayed product cell vertically;
touching and swiping the displayed product cell horizontally;
touching a displayed mix it up button within the cell to refresh the display with a new collection of products;
touching a displayed pin button within the cell to hold the product image within the cell while refreshing the cells that display other products;
selecting anchor products within a cell;
dynamically selecting product assortments; and
dynamically selecting product assortments based on a preselected user profile, which profile is created based on user metrics.

13. The computer implemented system of claim 12 wherein the device is a non-touch screen device having a pointing device and the steps are replaced by movement of the pointing device which translates into the motion of a pointer on the display.

14. A product explorer computer program product for use with a product having a touch screen, such program product allowing for an interface wherein tactile motion by a the user across the touch screen actuates a functionality and the computer program product being embodied in a non-transitory computer readable medium comprising computer instructions for:
electronically providing a user interface featuring a product display page that displays retail product imagery within a patchwork grid of cells, each cell illustrating a retail product therein;
electronically providing a user interface functionality to allow the user to tactilely select a retail product that is displayed within a given cell; and
electronically providing a user interface functionality to allow the user to tactilely initiate the appearance of additional information relating to the displayed product.

15. The computer program product of claim 14 wherein the computer instructions for tactilely initiating the appearance of additional information relating to the displayed product comprises at least one step from a group consisting of:
touching and swiping the displayed product cell vertically;
touching and swiping the displayed product cell horizontally;
touching a displayed mix it up button within the cell to refresh the display with a new collection of products;
touching a displayed pin button within the cell to hold the product image within the cell while refreshing the cells that display other products;
selecting anchor products within a cell;
dynamically selecting product assortments; and
dynamically selecting product assortments based on a preselected user profile, which profile is created based on user metrics.

16. The computer program product of claim 14 wherein the step of touching and swiping the displayed product cell vertically allows the user to control the amount of information the user obtains relative to the product that is displayed within the cell.

17. The computer program product of claim 14 wherein the step of touching and swiping the displayed product cell horizontally allows the user to view similar products to that displayed within the cell.

18. The computer program product of claim 14 wherein the step of touching a displayed mix it up button within the cell to refresh the display with a new collection of products changes the entire set of products that are displayed on the screen to another completely new set of products that are displayed within the cell on a new screen.

19. The computer program product of claim 14 wherein the step of touching a displayed pin button within the cell to hold the product image within the cell while refreshing the cells that display other products allows the user to identify a product of particular interest to the user and then reshuffle the remaining displayed collection of products, thereby retaining the product that the user has pinned in its original place on the display screen.

20. The computer program product of claim 14 wherein the step of selecting an anchor product within a cell allows the user to view related accessories and products in the other cells and, alternatively, select a new anchor product thereby allowing the user to view accessories and products that are related to that new anchor product.

21. The computer program product of claim 14 wherein the step of dynamically selecting product assortments allows the user to view cells that are assembled in such a way that the set of products come from either explicit selection by a merchandiser or selection via algorithm.

22. The computer program product of claim 14 wherein the step of selecting a mix it up button is alternatively replaced with a physical shaking of the device to produce the change of cells and products displayed on the screen.

23. The computer program product of claim 14 wherein the device is a non-touch screen device having a pointing device and the steps are replaced by movement of the pointing device which translates into the motion of a pointer on the display.
